(19) United States
(12) Patent Application Publication
(10) Pub. No.: US 2005/0086826 A1
(43) Pub. Date: Apr. 28, 2005

(54) Tunnel finisher with infrared feedback temperature control

(76) Inventor: Jeffrey Neal Frushtick, Denver, NC (US)

Correspondence Address: Adams Evans P.A., 2180 Two Wachovia Center, 301 S. Tryon Street, Charlotte, NC, 28282, US

(21) Appl. No.: 10/861,643

(22) Filed: Jun. 4, 2004

Related U.S. Application Data
(60) Provisional application No. 60/475,877, filed on Jun. 4, 2003.

(51) Int. Cl. F26B 19/00

(52) U.S. Cl. 34/218

(57) ABSTRACT

A garment finisher, including a heated enclosure having a garment entrance, a garment exit and a carrier for transporting garments at a predetermined rate of travel through the enclosure from the entrance to the exit. A temperature sensor is provided for sensing the temperature of the garment at at least one location within the enclosure. A feedback circuit interconnects the temperature sensor and a parameter controller for varying an operating condition, such as the temperature within the enclosure, the rate of travel of the garment through the enclosure or the moisture in the garment, of the finisher in response to a feedback signal from the temperature sensor indicating a out-of-variance garment temperature in relation to a preset desired garment temperature in order to bring the temperature of the garment back within variance of the preset desired garment temperature.

This application claims priority from Provisional Patent Application Ser. No. 60/475,877, filed on Jun. 4, 2003.

### TECHNICAL FIELD AND BACKGROUND OF THE INVENTION

This invention relates to a tunnel finishing apparatus and method. This type of apparatus finishes the garment by heating the garment that has been laundered, or by taking a new garment that is heated to a desired temperature for curing of wrinkle free chemicals for permanent press, and processing it through the apparatus for the purpose of removing wrinkles or heat setting the garment.

In a typical laundry, garments that have been washed and extracted of excess moisture are placed on a hanger and carried into a tunnel finisher with a conveyor system or a rolling rack. The garment is bathed in conditioning steam and then as the garment travels through the unit, it is “finished” with high velocity heated air.

The goal is to get the fabric to a temperature of 260-280 degrees F. If the temperature is too low, the polyester of the blended fabric will not relax and release the wrinkle. If the temperature is too high, the fabric can be damaged in several ways, from color loss to cracking and loss of fibers that can reduce the useful garment life.

In the curing process the wrong temperature will result in incomplete curing and a less-than-permanent crease and wrinkle resistance.

In prior art machines, temperature control is provided by using a thermal couple located in the process air chamber to measure the temperature of the heated air prior to the air being introduced or directed onto the garments. The feedback from this thermal couple translates to a temperature control device that adjusts the temperature coming from a heating source.

The garments enter the tunnel at a temperature lower than the set point temperature of the machine, typically a ambient room temperature. In most cases these garments are damp and contain residual moisture in the 40% range. It therefore takes some time for them to first dry and then to elevate in temperature. The normal cycle time in the machine is approximately 4 minutes for a finisher and 15 minutes for a curing oven. During this time the garments rise in temperature during their travel through the machine. A normal temperature set point for the tunnel finisher can be 300-310 degrees F.

Proper finishing of the garment will take place in the range of 260-280 degrees F. Users check the actual fabric temperature by applying heat tape—a chemically-treated tape that changes color in blocks to indicate the actual fabric temperature. If the heat tape shows a fabric temperature of above 280 degrees F., then the user will reduce the set point of the tunnel finisher, increase the speed of the conveyor through the finisher, or increase the moisture retention of the garments prior to their entrance into the machine, or some combination of these. The fabric temperature is very important to the finial quality of the product.

The present method is time-consuming and inaccurate. It does not see variations during a production shift, but only a snap shot of what is happening. As garment conditions change, and as lint buildup on the filtration system occurs, the actual heating profile of the machine will vary greatly, effecting the quality of the finish, and possibly effecting the garment life itself.

### SUMMARY OF THE INVENTION

Therefore, it is an object of the invention to provide an infrared temperature sensing device or system for a garment finishing apparatus such as a curing oven or a tunnel finisher.

It is another object of the invention to provide immediate and constant feedback to the control system of the actual garment temperature during the process of the garments through the tunnel finisher.

It is another object of the invention to control the actual garment temperature during the process of the garments through the tunnel finisher by means of infrared temperature sensing and feedback control of appropriate operating parameters.

It is another object of the invention to accumulate data reflecting the actual garment temperature during the process of the garments through the tunnel finisher by means of infrared temperature sensing and feedback control of appropriate operating parameters for purposes of temperature control or for storage and subsequent use.

These and other objects of the present invention are achieved in the preferred embodiments disclosed below by providing a garment finisher, comprising a heated enclosure having a garment entrance, a garment exit and a carrier for transporting garments at a predetermined rate of travel through the enclosure from the entrance to the exit. A temperature sensor senses the temperature of the garment at at least one location within the enclosure, and a feedback circuit interconnecting the temperature sensor and a parameter controller varies an operating condition of the finisher in response to a feedback signal from the temperature sensor indicating a out-of-variance garment temperature in relation to a preset desired garment temperature in order to bring the temperature of the garment back within variance of the preset desired garment temperature.

According to one preferred embodiment of the invention, the parameter controller is adapted to vary the temperature within the heated enclosure.

According to another preferred embodiment of the invention, the parameter controller is adapted to vary the rate of travel of the garment through the heated enclosure.

According to yet another preferred embodiment of the invention, the parameter controller is adapted to vary the moisture level of the garment.

According to yet another preferred embodiment of the invention, the parameter controller is adapted to maintain the predetermined temperature of the garment by varying a condition selected from the group consisting of the temperature within the heated enclosure, the rate of travel of the garment through the heated enclosure, and the moisture level of the garment.

According to yet another preferred embodiment of the invention, a data storage apparatus is provided for storing data representing the temperature of the garments in relation to operating conditions of the tunnel finisher.

Preferably, the temperature sensor comprises a infrared sensor.

According to yet another preferred embodiment of the invention, a plurality of temperature sensors are positioned to sense the temperature of the garment at a plurality locations within the enclosure, and at least some of the temperature sensors comprises a infrared sensor.

An embodiment of the method according to the invention comprises the steps of providing a heated enclosure having a garment entrance, a garment exit and a carrier for transporting garments at a predetermined rate of travel through the enclosure from the entrance to the exit, and sensing the temperature of the garment at at least one location within the enclosure. An operating condition of the finisher is varied in response to a feedback signal from the temperature sensor indicating a out-of-variance garment temperature in relation to a preset desired garment temperature in order to bring the temperature of the garment back within variance of the preset desired garment temperature.

Preferably, the step of sensing the temperature comprises the step of sensing the temperature by means of an infrared sensor.

Preferably, the method includes the steps of positioning a plurality of temperature sensors in relation to the garment and sensing the temperature of the garment at a plurality locations within the enclosure, where at least some of the temperature sensors comprises a infrared sensor.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a side view of a tunnel finisher according to a preferred embodiment of the present invention;

FIG. 2 is a front view of the tunnel finisher in FIG. 1;

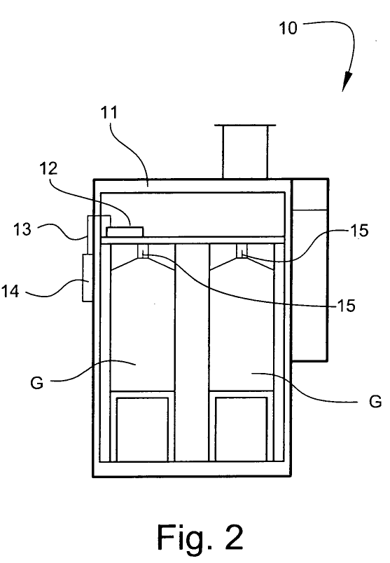

FIG. 3 is a top, exploded view of a tunnel finisher according to a preferred embodiment of the invention, with an added heating module; and

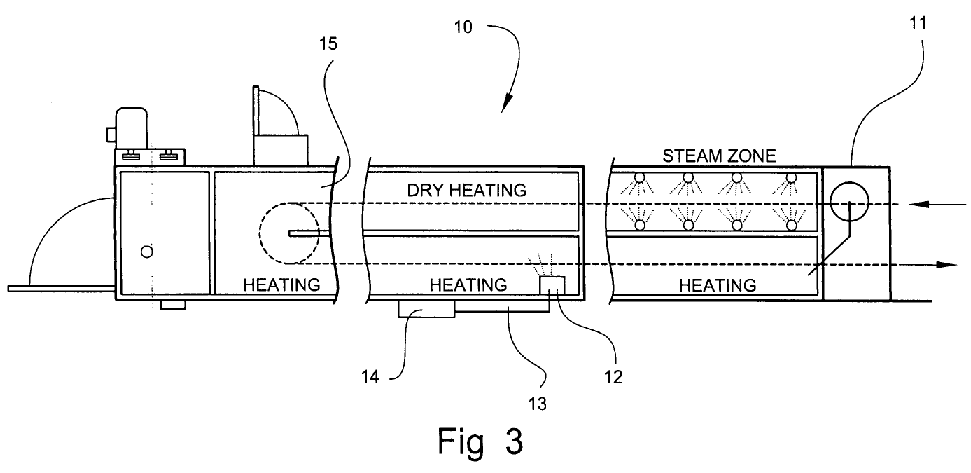

FIG. 4 is an alternative embodiment showing the use of a plurality of sensors and data storage.

### DESCRIPTION OF THE PREFERRED EMBODIMENT AND BEST MODE

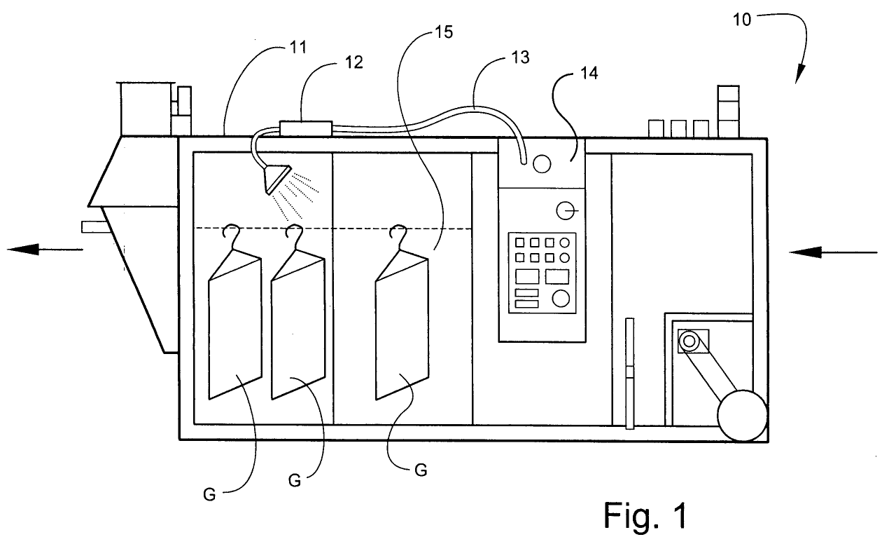

Referring now specifically to the drawings, a tunnel finisher according to the present invention is illustrated in FIG. 1 and shown generally at reference numeral 10, and comprises a housing 11 in which the operating components are contained. An infrared temperature sensor 12, including a suitable communication device 13 for transmitting detected temperatures to the control system 14 of the tunnel finisher 10, is mounted in the housing 11 to provide immediate and constant feedback to the control system 14 of the tunnel finisher of the actual garment temperature during the movement of garments “G” through the housing 11 on a conveyor 15.

The infrared sensor 12 is installed in the heated dry finishing area of the housing 11, as shown in FIG. 1, where the garment temperature rises quickly once all the moisture is driven off. The infrared sensor 12 measures the actual fabric temperature in a sample area as the garments move past.

If the temperature of the fabric exceeds a range, the system reduces the temperature inside the finisher 10 to protect the garments. If the temperature falls below a range, the finisher adjusts itself to allow the fabric temperature to rise back into the correct range.

Thus, the control sensor 14 to which the infrared sensor 12 is connected constantly adjusts the fabric temperature detected by the infrared sensor 12 as compared to the airflow temperature. This continuous adjustment creates the conditions to provide constant garment quality, insure that garments will not be damaged by excessive heat, and that the processing will be in the correct parameters.

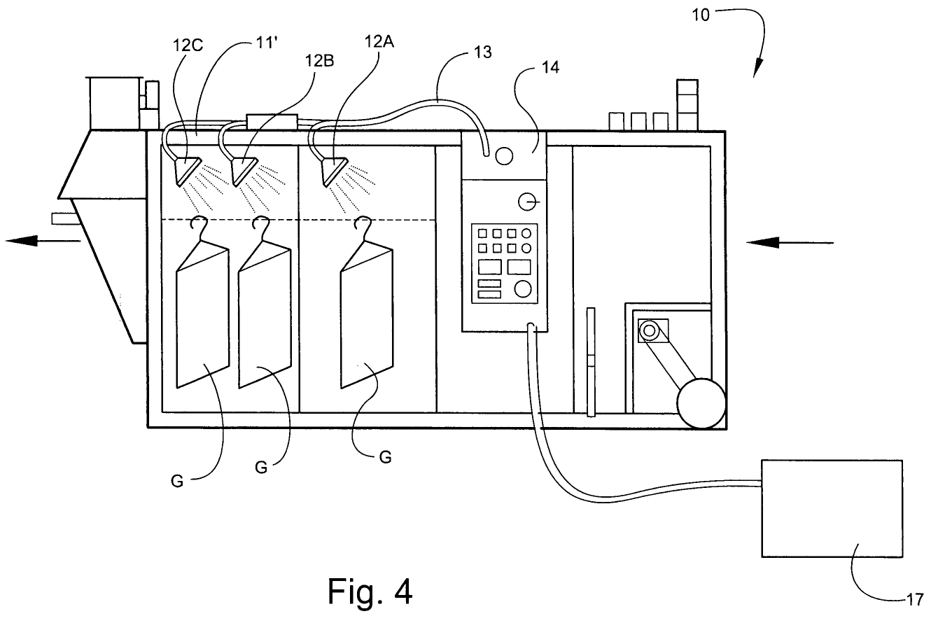

As is shown in FIG. 4, garment finisher 10′ includes several infrared sensors 12A, 12B, 12C may be used, positioned so as to track the temperature of the garments in varying locations as they progress through the housing 11. Appropriate software may be used to compare actual versus expected garment temperatures, provide an alarm when parameters are exceeded, as well as provide feedback signals to control the set point of the tunnel finisher, the speed of the conveyor through the finisher, the moisture retention of the garments prior to their entrance into the machine, or some combination of these. Software can also be used to document and store in a data storage device 17 data representing the temperature of the garments in relation to operating values of the tunnel finisher 10 for long-range evaluation and for liability and warranty claim purposes.

A method and apparatus for finishing garments is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

1. A garment finisher, comprising:
(a) a heated enclosure having a garment entrance, a garment exit and a carrier for transporting garments at a predetermined rate of travel through the enclosure from the entrance to the exit;
(b) a temperature sensor for sensing the temperature of the garment at at least one location within the enclosure; and
(c) a feedback circuit interconnecting the temperature sensor and a parameter controller for varying an operating condition of the finisher in response to a feedback signal from the temperature sensor indicating a out-of-variance garment temperature in relation to a preset desired garment temperature in order to bring the temperature of the garment back within variance of the preset desired garment temperature.

2. A finisher according to claim 1, wherein the parameter controller is adapted to vary the temperature within the heated enclosure.

3. A finisher according to claim 1, wherein the parameter controller is adapted to vary the rate of travel of the garment through the heated enclosure.

4. A finisher according to claim 1, wherein the parameter controller is adapted to vary the moisture level of the garment.

5. A finisher according to claim 1, wherein the parameter controller is adapted to maintain the predetermined temperature of the garment by varying a condition selected from the group consisting of the temperature within the heated enclosure, the rate of travel of the garment through the heated enclosure, and the moisture level of the garment.

6. A finisher according to claim 1, and including a data storage apparatus for storing data representing the temperature of the garments in relation to operating conditions of the tunnel finisher.

7. A finisher according to claim 1, 2, 3, 4, 5 or 6, wherein the temperature sensor comprises a infrared sensor.

8. A finisher according to claim 1 or 6, and including a plurality of temperature sensors positioned to sense the temperature of the garment at a plurality locations within the enclosure.

9. A finisher according to claim 8, wherein at least some of the temperature sensors comprises a infrared sensor.

10. A method of controlling the temperature of a garment, comprising the steps of:
(a) providing a heated enclosure having a garment entrance, a garment exit and a carrier for transporting garments at a predetermined rate of travel through the enclosure from the entrance to the exit;
(b) sensing the temperature of the garment at at least one location within the enclosure; and
(c) varying an operating condition of the finisher in response to a feedback signal from the temperature sensor indicating a out-of-variance garment temperature in relation to a preset desired garment temperature in order to bring the temperature of the garment back within variance of the preset desired garment temperature.

11. A method according to claim 10, wherein the step of varying an operating condition comprises the step of varying the temperature within the heated enclosure.

12. A method according to claim 10, wherein the step of varying an operating condition comprises the step of varying the rate of travel of the garment through the heated enclosure.

13. A method according to claim 10, wherein the step of varying an operating condition comprises the step of varying the moisture level of the garment.

14. A method according to claim 10, wherein the step of varying an operating condition comprises the step of varying the predetermined temperature of the garment by varying a condition selected from the group consisting of temperature within the heated enclosure, the rate of travel of the garment through the heated enclosure, and the moisture level of the garment.

15. A method according to claim 10, and including the step of storing data representing the temperature of the garments in relation to operating conditions of the tunnel finisher.

16. A method according to claim 10, 11, 12, 13, 14 or 15, wherein the step of sensing the temperature comprises the step of sensing the temperature by means of an infrared sensor.

17. A method according to claim 10 or 15, and including the steps of positioning a plurality of temperature sensors in relation to the garment and sensing the temperature of the garment at a plurality locations within the enclosure.

18. A method according to claim 17, wherein at least some of the temperature sensors comprises a infrared sensor.
